(19) United States
(12) Patent Application Publication
(10) Pub. No.: US 2013/0084158 A1
(43) Pub. Date: Apr. 4, 2013

(54) LIFTING SYSTEM

(71) Applicant: Gregory Garrett Evans, Haiku, HI (US)

(72) Inventor: Gregory Garrett Evans, Haiku, HI (US)

(21) Appl. No.: 13/251,914

(22) Filed: Oct. 3, 2011

(51) Int. Cl. F16M 13/02

(52) U.S. Cl. 414/800; 248/284.1

(57) ABSTRACT

A lifting system suitable for garages for storing objects above a vehicle comprises a frame having a central opening. The frame is formed of two side bars and two end bars, each side bar being adjustably attached to the end bar for adjusting the size of the central opening. A first pair of swing arms is pivotably attached to the first side bar and a second pair of swing arms is pivotably attached to the second side bar. There is a pivot connection for each swing arm for pivotably connecting each swing arm to a supporting structure above the frame. A hoist system activated by a switch is used for raising and lowering the frame.

### BACKGROUND

Lack of storage space is a common problem. A potential storage area that is under utilized is the space in garages and the like above vehicle level. How it is definable is to easily access this storage place to safely store and retrieve objects.

A variety of systems are known for raising objects. For example see, U.S. Pat. Nos. 5,263,687; 5,897,104; 6,017,018; 6,056,274; 6,361,022; 6,959,918; 7,533,869 and U.S. Publication No. 2010/0283021.

However, there remains a need for a lifting system that can be used in locations such as garages that is inexpensive, adjustable for different sized objects, and can easily be used for raising, lowering, and storing objects.

### SUMMARY

The present invention provides a lifting system that satisfies this need. A preferred lifting system comprises a frame having a central opening. The frame is formed of first and second side bars and first and second end bars. Each side bar is adjustably attached to each end bar so that the size of the central opening can be adjusted. The lifting system also includes a first pair of swing arms pivotally attached to the first side bar at positions spaced from each other. There is also a second pair of swing arms pivotally attached to the second side bar at positions spaced from each other. There is a pivot connection for each swing bar for pivotably connecting each swing arm to a supporting structure, such as the ceiling above the frame. The swing arms allow lowering and raising of the frame while keeping the frame parallel to, for example, a floor.

A hoist system is provided for raising and lower the frame toward and away from the supporting structure, and a switch is provided for activating the hoist system. Preferably the switch is readily accessible, and placed no more than six feet above floor level.

Preferably at least one of the bars has a channel with an open face oriented to face the supporting structure. The channel can be used for placing a hook therein for supporting objects.

The lift system can comprise a motor driving a winch for pulling and releasing at least one cable, the cable being connected to multiple locations on the frame, using pulleys.

In one version of the invention, the lifting system can include a platform supported by the frame. Preferably the platform is removeable from the frame without tools. Due to the pivot connections it is possible to raise and lower the lifting system while keeping the platform substantially parallel to the floor.

In a method for raising and lowering an object, the frame is placed at a height suitable for placing the object to be supported by the frame, the object is supported with the frame, and then the switch is activated to raise the frame with the supported object thereon. Subsequently the switch can be activated to lower the frame for access to the object.

### DRAWINGS

These an other features, aspects, and advantages of the present invention will become better understood with reference to the following description, appended claims, and accompanying drawings where:

FIG. 1 is a perspective view of a first lifting system that has features of the present invention shown mounted to a ceiling in a garage above an automobile;

FIG. 2 is a perspective view of a lifting system of FIG. 1 taken above the lifting system, looking downwardly on the lifting system, with an optional platform and showing it in a raised position in phantom;

FIG. 3 is a perspective view showing a portion of the lifting system of FIG. 1 taken from the bottom side of the lifting system;

FIG. 4 is a perspective view of the lifting system of FIG. 1 where the lifting system includes hooks; and

FIG. 5 is perspective view from the bottom of a second version of the lifting system according to the present invention.

### DESCRIPTION

With reference to the figures, a lifting system 10 comprises a frame 12 defining a central opening 14. The frame 12 is formed from a pair of parallel elongated side bars 16A and 16B where each side bar is adjustably attached to a pair of end bars 18A, 18B. The designation of which bars are side bars and which are end bars is arbitrary for convenience in describing the invention. Either pair of parallel bars can be considered side bars and the other pair of parallel bars can be considered the end bars.

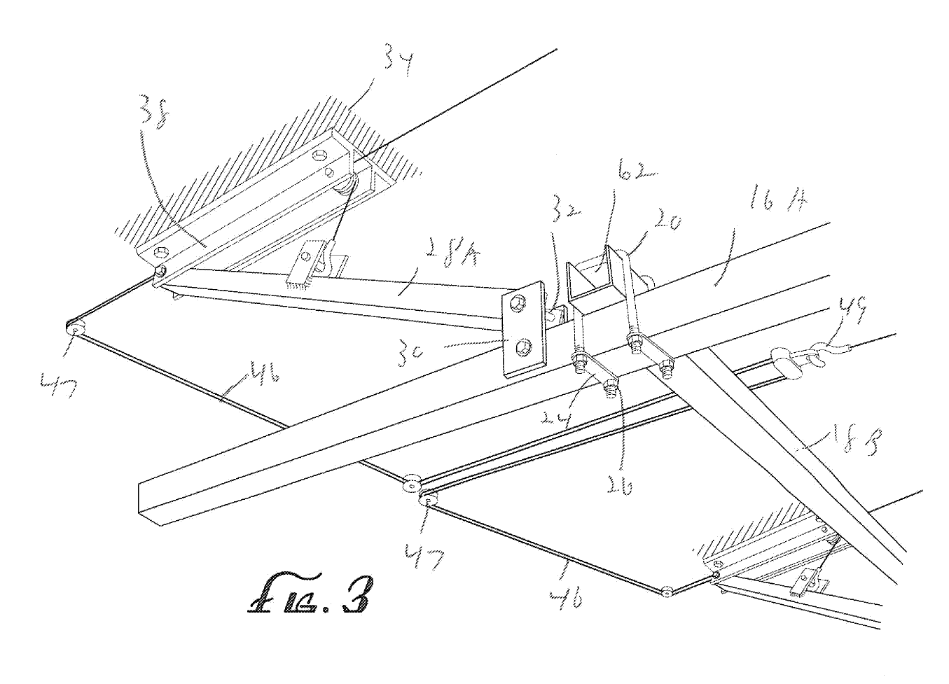

Adjustment of the size and shape of the opening 14 is provided by, as best shown in FIG. 3, a pair of U-shaped clamps 20 positioned over the end portion of each side bar, one clamp 20 on either side of the side bar. Each clamp has a pair of downwardly extending threaded legs 22, with each leg 22 of each clamp 20 secured to the proximate leg 22 of the other clamp of each set by a bar 24 held in place by nuts 26 threaded onto the end of the threaded leg. Merely by loosening the nuts, the side bars 16A, 16B can slide along the end bars 18A, 18B for adjusting the size and shape of the central opening 14.

Generally the central opening 14 is rectangular with the end bars 18A, 18B parallel to each other and the side bars 16A, 16B parallel to each other. But as evident from the drawings, it is possible to move only one end of each end bar, while maintaining the other end stationary, so that configurations that is not rectangular is possible. However, due to the limited amount of movement at only one end of an end bar 18 by any configuration is a substantially rectangular central opening 14.

In a preferred version of the invention the frame 12 comprises a first pair of swing arms 28A pivotally attached to the first side bar 16A at positions spaced apart from each other, and a second pair of swing arms 28B pivotally attached to the second side bar 16B at positions spaced apart from each other. Each attachment is by a bracket 30 attached to the respective side bar 16, each bracket 80 having a pivot rod 32 supported by the bracket 20, with the swing arms 28 mounted to pivot on the bracket 30. This provides a pivot connection for each swing arm 28A, 28B, which also is pivotally connected to a supporting structure such as a ceiling 34. As best shown in FIG. 3, the end 36 of each swing arms 28 distal from the frame 12 is pivotally supported by a bracket 38 mounted on the supporting structure 34.

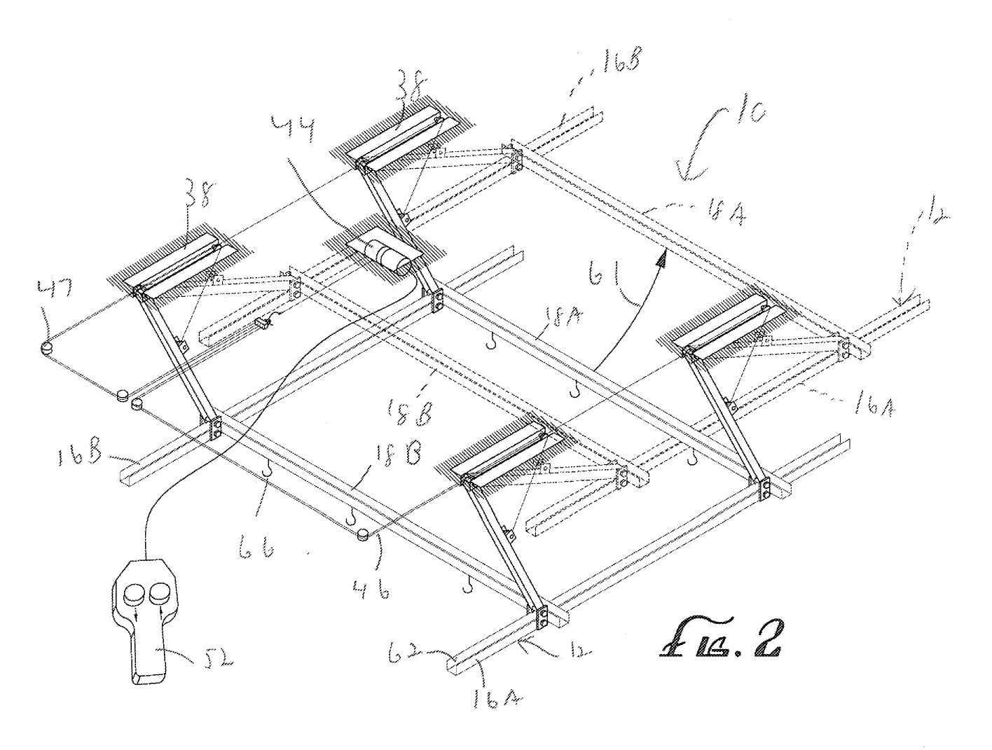

A hoist system used for raising and lowering the frame 12 toward and away from the supporting structure 34 above and below a floor 42. The hoist system can take many configurations. In one configuration, a motor driven winch 44 is mounted on the supporting structure 34, and uses cables 46 for raising and lowering the frame 12. The frame 12 is shown in raised position in FIG. 2 in phantom. The cables 46 are attached to various points of the frame by use of a system of pulleys 47 and a hook 49 so that frame 12 can be lowered and raised, while maintaining the frame 12 substantially parallel to a floor 42.

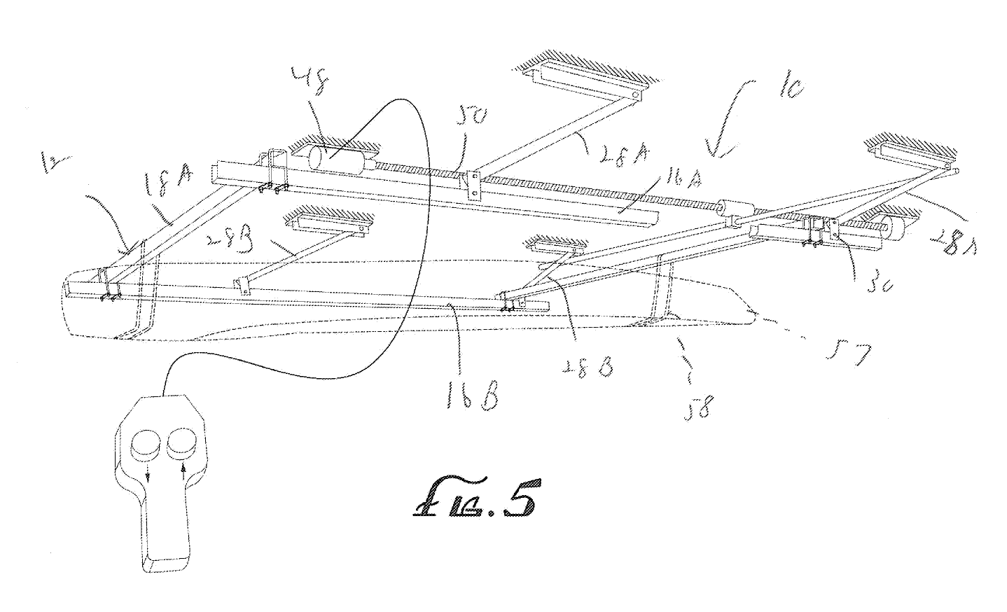

In a version of the invention shown in FIG. 5, a different type of hoist system is used where a motor 48 drives a threaded rod 50, which is attached to the frame so that turning the rod in one direction raises the frame and turning the rod in the other direction lowers the frame. There is a motor 48 and threaded rod 50 for each one of the side bars.

Each version of the invention is activated by a switch 52, which in the version shown has two buttons, a button 53A for raising the frame, and a button 53B for lowering the frame. The switch 52 is shown as having an insulated control wire 54 connected to the motor. However the system can be wireless, and different types of switches than that shown in the drawings can be used. Preferably the switch 52 is no more than six feet above the floor 42 for easy access so it is reachable from the floor 42.

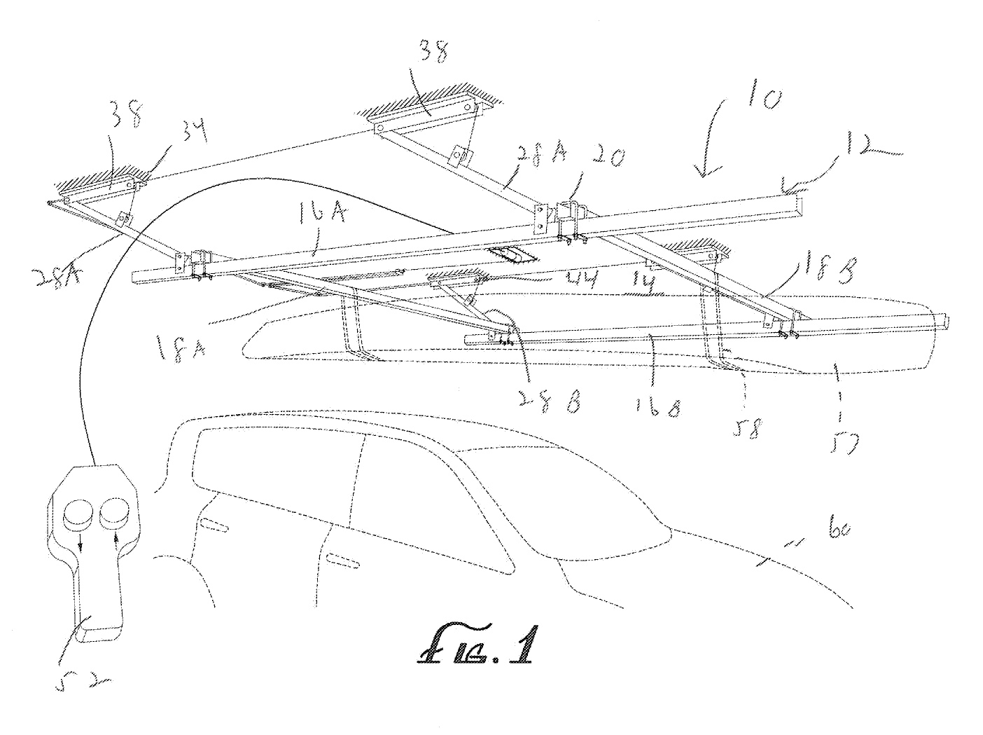

FIGS. 1 and 5 show one application of the system 10 wherein a kayak 57 is slung underneath the frame 12 and held in position by bungee cords 58. In this version, kayak 57 can be raised and lowered from a vehicle 60. To raise the kayak 57, the frame 12 is positioned at a height suitable for supporting the kayak 57 to be lifted. The kayak 57 is secured to the frame 12 with the bungee cords 58 or other connectors, and the frame is raised by activating the switch 52 thereby providing easy storage for the kayak 57. Arrow 61 in FIG. 2 shows the direction of movement of the frame 12 as it is raised from a lower position (solid lines) to a raised position (dashed lines). When it is time to lower the kayak 57 onto the vehicle 60 for transportation, merely by activating the switch 52, the frame 12 can be lowered to place the kayak 57 on top of the vehicle 60.

In an optional configuration, one or more of the bars 16A and 16B, 18A and 18B, and preferably all of the bars, are channels with an open face 62 facing towards the ceiling 34 for supporting hooks 66. The hooks 66 can be used for supporting a variety of different objects for storage purposes. For example the hooks can be used for beach chairs, toys, lawn mowers, garden tools, and the like.

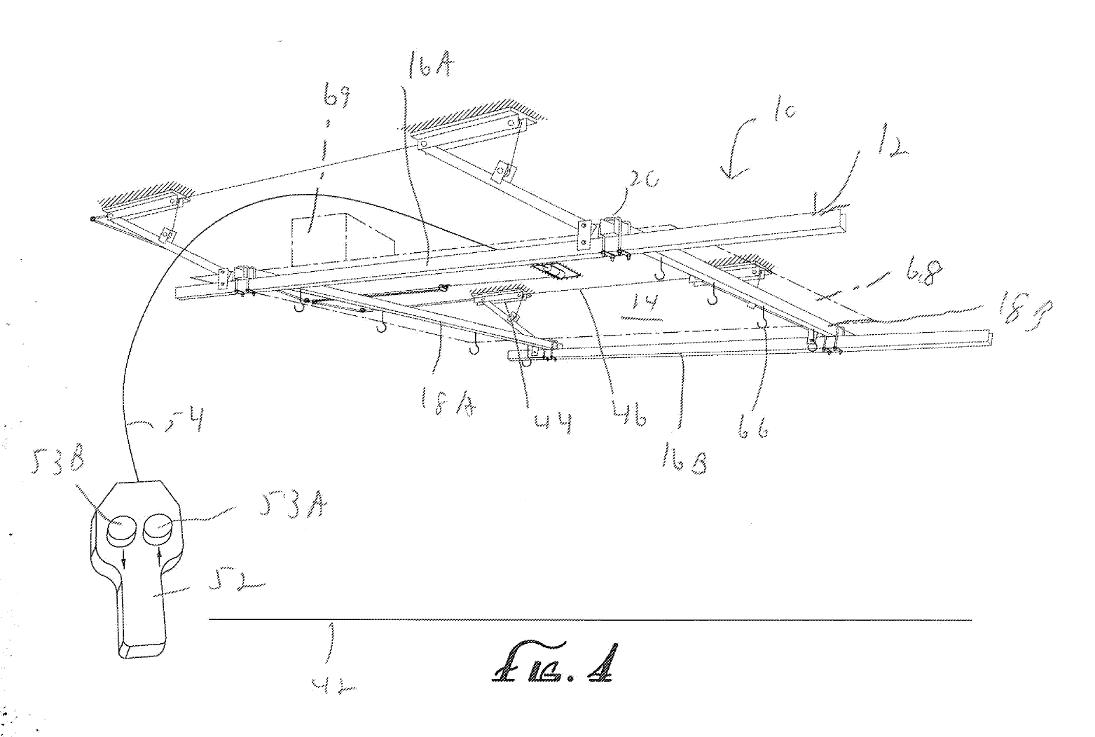

As shown in FIG. 4, the frame 12 can be used for supporting a platform 68. The platform 68 can be used for supporting a variety of different objects, such as boxes 69 containing household items and the like. It is particularly useful for objects that cannot be slung from underneath the frame or supported by the hooks 66. The lifting system 10 provides easy access to such objects, unlike the typical storage on a platform on rafters in the ceiling of a garage where access is available only through a ladder. Preferably the frame 68 is just positioned on the frame without fasteners so that it can be removed without tools. A similar no-tool result can be obtained by using hand tightenable clamps, such as C-clamps.

The frame preferably is made out of a strong, lightweight metal, such as aluminum, iron, or stainless steel. It can also be made of an engineering plastic.

Similarly the platform can be made out of any material, but typically wood or wood substitute, or fiber board.

This invention has significant advantages. It is easily and inexpensively constructed. It can be used for raising and lowering objects in a multitude of configurations, where the object can be slung underneath the frame, hung by hooks from the frame, or supported on a platform supported by the frame. A variety of hoist systems can be used.

Although the present invention is described in consideration detail with reference to certain preferred versions thereof, other versions are possible. For example, the motor used, particularly the motor combined with a winch configuration, can be recessed into a ceiling rather than placed on the ceiling surface. Therefore the subject claims should not be limited to the preferred versions described.

All the features disclosed in this specification (including any accompanying claims, abstract, and drawings) may be replaced by alternative features serving the same, equivalent or similar purpose, unless each feature disclosed is one example only of a generic series of equivalent or similar features.

What is claimed is:

1. A lifting system comprising:
a) a frame having a central opening and formed of first and second side bars and first and second end bars, each side bar being adjustably attached to the end bars for adjusting the size of the central opening;
b) a first pair of swing arms pivotally attached to first side bar at positions spaced from each other and a second pair of swing arms pivotally attached to second side bar at positions spaced from each other;
c) a pivot connection for each swing arm for pivotally connecting each swing arm to a supporting structure above the frame;
d) a hoist system for raising and lowering the frame toward and away from the supporting structure; and
e) a switch for activating the hoist system.

2. The lifting system of claim 1 attached to the supporting structure by the pivot connections.

3. The lifting system of claim 2 wherein the supporting structure is above a floor.

4. The lifting system of claim 3 wherein the switch is no more than six feet above the floor so it is reachable from the floor.

5. The lifting system of claim 1 wherein at least one of the bars is a channel with an open face oriented to face the supporting structure.

6. The lifting system of claim 5 wherein all of the bars are a channel with an open face oriented to face the supporting structure.

7. The lifting system of claim 5 comprising a plurality of hooks supported in the channel.

8. The lifting system of claim 1 comprising a platform supported by the frame.

9. The lifting system of claim 8 wherein the supporting structure is above a floor, and the pivot connections are adapted to allow the platform to be raised and lowered while remaining parallel to the floor.

10. The lifting system of claim 1 wherein the hoist system comprises a motor driving a winch for pulling and releasing at least one cable, the cable being connected to the frame.

11. The lifting system of claim 10 wherein the hoist system comprises pulleys for the cable.

12. The lifting system of claim 5 comprising at least one hook supported in the channel.

13. A lifting system for raising and lowering objects relative to a ceiling above a floor comprising:
a) a frame having a central opening and formed of first and second side bars and first and second end bars, each side bar being adjustably attached to the end bars for adjusting the size of the central opening, at least one of the bars being a channel with an open face oriented to face the ceiling;
b) a first pair of swing arms pivotally attached to first side bar at positions spaced from each other and a second pair of swing arms pivotally attached to second side bar at positions spaced from each other, the pivot connections being adapted to allow the frame to be raised and lowered while remaining parallel to the floor;
c) a pivot connection for each swing arm for pivotally connecting each swing arm to a supporting structure above the frame;
d) a hoist system for raising and lowering the frame toward and away from the ceiling;
e) a switch for activating the hoist system; and
f) a plurality of hooks supported in the channel.

14. A method for raising and lowering an object comprising the steps of:
a) placing the frame of the lifting system of claim 1 at a height suitable for placing the object to be supported by the frame;
b) supporting the object with the frame;
c) activating the switch to raise the frame with the supported object; and
d) after step (c), activating the switch to lower the frame for access to the object.

15. The method of claim 14 wherein the step of supporting the object comprises attaching the object to the frame below the frame.

16. A method for raising and lowering an object comprising the steps of:
a) placing the frame of the lifting system of claim 12 at a height suitable for placement of the object supported by the hook;
b) supporting the object with the hook;
c) activating the switch to raise the frame with the supported object; and
d) after step (c), activating the switch to lower the frame for access to the object.

17. The system of claim 8 wherein the platform is removable from the frame without tools.

18. The method of claim 14 wherein the frame has hooks depending there from, and the step of supporting the object with a frame comprises attaching the object to the hooks.

19. The method of claim 15 wherein the object is a kayak.
